(19) United States
(12) Patent Application Publication
(10) Pub. No.: US 2017/0080264 A1
(43) Pub. Date: Mar. 23, 2017

(54) METHODS AND COMPOSITIONS FOR ENHANCED REINFORCEMENT FOR REFRACTORY FIRE CONTAINMENT WALLS

(71) Applicant: Alonso P. Rodriguez, Pasadena, CA (US)

(72) Inventor: Alonso P. Rodriguez, Pasadena, CA (US)

(21) Appl. No.: 15/309,170

(22) PCT Filed: May 5, 2015
(86) PCT No.: PCT/US15/29289

§ 371 Date: Nov. 4, 2016

Related U.S. Application Data
(60) Provisional application No. 61/996,311, filed on May 5, 2014.

(51) Int. Cl. A62C 2/06; C04B 35/66; C04B 20/00; B28B 1/16; C04B 16/12; C04B 14/46; C04B 14/34; C04B 14/22; C04B 28/04; C04B 14/48

(52) U.S. Cl. CPC A62C 2/06; C04B 28/04; C04B 35/66; C04B 20/0048; C04B 14/48; C04B 16/12; C04B 14/4618; C04B 14/4625; C04B 14/4631; C04B 14/34; C04B 14/22; B28B 1/16; C04B 2111/28

(57) ABSTRACT

The invention described is a reinforced refractory fire containment wall panel, the panel cast from a reinforced refractory composition. The refractory composition contains cement, a binder, a matrix material comprising 300 series stainless steel fibers and organic fibers, and a refractory aggregate comprising aluminum oxide, calcium oxide, iron oxide and silicon dioxide or a combination thereof, and a reinforcing material. The invention also describes methods of making the reinforced refractory fire containment wall panel.

### CROSS-REFERENCE TO RELATED APPLICATIONS

This application claims the benefit of U.S. Provisional Patent Application No. 61/996,311, filed on May 5, 2014, the contents of which are incorporated herein by reference in their entirety.

### BACKGROUND

It is crucial that long duration fires that are accompanied by extreme heat flux be contained or limited to the fire's point of origin, as these fires are difficult to extinguish and can rapidly spread throughout an installation. Examples of these conflagration events are fires in refineries, large energy-storage battery banks, electrical transformers, and oil-filled transformers in power substations.

A modular fire containment wall cast from refractory concrete, as described in U.S. Pat. Nos. 8,118,925 and 8,221,540, has been tested to successfully withstand fires characterized by a very rapid increase in temperature and long exposure times, such as mineral oil fires. The fire containment walls described in the patents meet the ASTM E-119 Standard Test Methods for Fire Tests of Building Construction and Materials. The refractory fire containment walls described in U.S. Pat. Nos. 8,118,925 and 8,221,540 typically consist of a number of grooved columns and modular panels. The modularity feature allows the fire walls to be configured to the width and height needed to effectively contain fires associated with transformers of a large range of sizes, and also handle extreme wind-induced and seismic mechanical loads.

However, these fire containment walls are not able to resist the impact of high level ballistics or are able to effectively mitigate sound. Thus, there is a need for fire containment walls that can resist the impact of high level ballistics as well as fire containment walls that can mitigate sound.

A typical modular panel in a fire containment wall is 3 feet high and 7 to 8 feet long. The cost of constructing a fire containment wall is primarily dependent on the total number of columns in the structure. A longer panel would require fewer columns in the structure, and would cost less to make. However, longer panels have been difficult and costly to produce, and may not have the resistance necessary to withstand pressure caused by high wind and other conditions. To produce a modular panel of longer lengths, increased reinforcement of the panels is necessary. Thus, there is a need for reinforced modular panels for a fire containment wall that is longer than about 8 feet.

Accordingly, there is a need for materials and methods for producing fire containment walls which provide sufficient protection against large, very long-lasting and hot fires, and are resistant to ballistics, sound, and high pressure. The invention satisfies this need.

### SUMMARY

According to one embodiment of the present invention, there is provided a reinforced refractory fire containment wall panel, the panel cast from a reinforced refractory composition, the refractory composition comprising: a) a cement; b) a binder; c) a matrix material comprising 300 series stainless steel fibers and organic fibers, and a refractory aggregate comprising aluminum oxide, calcium oxide, iron oxide and silicon dioxide or a combination thereof; and d) a reinforcing material. In one embodiment, the reinforcing material can be an organic material. In one embodiment, the organic material comprises aramid fibers, carbon, composites, or a combination thereof. In one embodiment, the reinforcing material can be an inorganic material. In another embodiment, the inorganic material comprises stainless steel, special high temperature glass, or a combination thereof.

According to another embodiment of the present invention, there is provided a method of making a reinforced refractory fire containment wall panel, the method comprising: a) pouring a panel comprising a refractory composition into a cast, the refractory composition comprising i) a cement; ii) a binder; and iii) a matrix material comprising 300 series stainless steel fibers and organic fibers, and a refractory aggregate comprising aluminum oxide, calcium oxide, iron oxide and silicon dioxide or a combination thereof; b) adding reinforcing material to the panel cast from a refractory composition; and c) pouring the refractory composition into remaining area of the cast. In one embodiment of the method, the reinforcing material can be an organic material. In another embodiment of the method, the organic material comprises aramid fibers, carbon, composites, or a combination thereof. In one embodiment of the method, the reinforcing material can be an inorganic material. In one embodiment of the method, the inorganic material comprises stainless steel, special high temperature glass, or a combination thereof.

According to another embodiment of the present invention, there is provided a method of making a reinforced refractory fire containment wall panel, the method comprising adding reinforcing material to a panel comprising a refractory composition, the refractory composition comprising: a) a cement; b) a binder; and c) a matrix material comprising 300 series stainless steel fibers and organic fibers, and a refractory aggregate comprising aluminum oxide, calcium oxide, iron oxide and silicon dioxide or a combination thereof. In one embodiment of the method, the reinforcing material can be an organic material. In one embodiment of the method, the organic material comprises aramid fibers, carbon, composites, or a combination thereof. In one embodiment of the method, the reinforcing material can be an inorganic material. In another embodiment of the method, the inorganic material comprises stainless steel, special high temperature glass, or a combination thereof.

### DRAWINGS

These and other features, aspects and advantages of the present invention will become better understood with reference to the following description, appended claims and accompanying drawings where:

FIG. 1 is an elevation view of a fire containment wall having features of the invention;

FIG. 2 is a perspective view of a partially completed fire containment wall having features of the invention;

FIG. 3 is a perspective view of a reinforced refractory fire containment panel of the invention with embedded reinforcement material;

FIG. 4 is a perspective view of a reinforced refractory fire containment panel of an additional embodiment of the invention with reinforcement material on the surface of the panel;

FIG. 5 is a side view of a tapered reinforced refractory fire containment panel of an additional embodiment of the invention;

FIG. 6 is a graph showing the Modulus of Rupture (MOR) incidence for different lengths of a refractory fire containment panels for four different wind speeds;

FIG. 7 is a graph showing the Modulus of Rupture (MOR) incidence for different lengths of reinforced refractory fire containment panels of one embodiment of the invention for four different wind speeds;

FIG. 8A is a plan view of a tapered reinforced refractory fire containment panel of one embodiment of the invention;

FIG. 8B is a cross section view of a tapered reinforced refractory fire containment panel of FIG. 8A taken across line 8-8; and

FIG. 8C is a perspective view of a tapered reinforced refractory fire containment panel of FIG. 8A.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

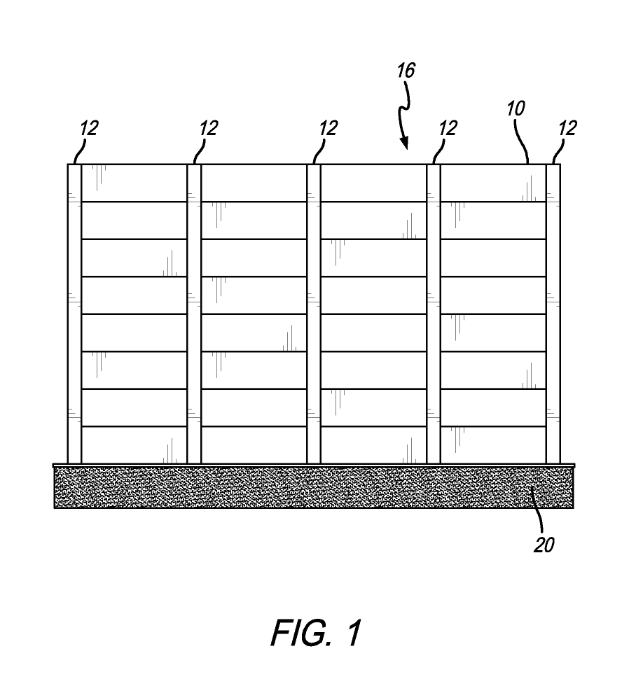

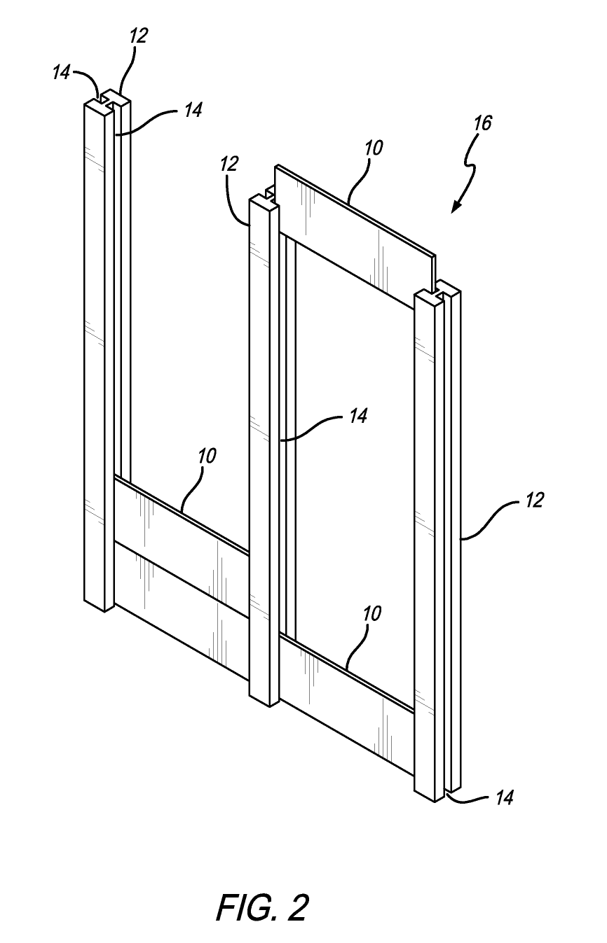

The refractory fire containment walls 16 described in U.S. Pat. Nos. 8,118,925 and 8,221,540, both incorporated by reference herein, comprise vertical beams 12 and panels 10, as shown in FIGS. 1 and 2. The refractory fire containment wall panels 10 are made of a concrete refractory material comprising cement, a binder such as calcium silicate, calcium aluminate, or aluminum silicate, water, and a matrix material. The matrix material comprises both stainless steel fibers and organic fibers.

The cement can be any suitable cement, such as Portland cement. The binder can be any suitable binder, such as calcium silicate or aluminum silicate.

Where the refractory concrete comprises calcium silicate and Portland cement, the water content is typically between about 10% and about 15% of the combined weight of the calcium silicate, Portland cement and water, more typically between about 11% and about 12%.

In addition to stainless steel fibers and organic fibers, the matrix typically comprises a variety of other mineral fillers. A typical premix of cement, binder and the non-stainless steel and non-organic portion of the matrix contains 40% to 60% (by weight) aluminum oxide, 0% to 20% (by weight) aluminum silicate, up to 30% cement, smaller amounts of crestobalite silica and quartz silica, and water.

An exemplar of such typical premix contains 44.5% (by weight) silicon dioxide, 34.1% (by weight) aluminum oxide, 16.5% (by weight) calcium oxide, 1.8% (by weight) ferric oxide and 13% water.

The stainless steel fibers can be 304 type stainless steel fibers. Other types of stainless steel from the 300 Series can also be used to make the fibers, such as: 301, 302, 303, 309, 316, 321 and 347. Typically, the weight percentage of the stainless steel fibers within the dry refractory mix (before water is added) is between about 1.2% and about 1.6% (by weight) of the dry refractory mix.

The stainless steel fibers are preferably corrugated to increase the effective surface area of the fibers and to facilitate their bonding and attachment within the matrix. The stainless steel fibers each have a length of about 1 inch, a width of about 0.045 inch and a thickness of about 0.02 inch. A typical stainless steel fiber that can be used in the invention has a base section having a length of about 0.18 inch, followed by nine alternating positive and negative corrugations. Each corrugation has a height of about 0.0075 inch and a length of about 0.08 inch long. After the series of nine corrugations, the particle terminates with a second, oppositely disposed base section having a length of about 0.1 inch. Such stainless steel fibers can be purchased from Fibercon International of Evans City, Pa.

The organic fibers provide minute channels when they are melted during a fire in order to facilitate gas venting without fracturing the refractory. These fibers also mitigate crack formation during curing. The organic fibers can comprise polypropylene fibers, preferably in excess of 90% polypropylene fibers. Typically, at least about 90% of the organic fibers have a length between about 0.2 inch and about 0.3 inch and a diameter between about 0.001 inch and about 0.002 inch.

As mentioned above, the refractory fire containment walls 16 described in U.S. Pat. Nos. 8,118,925 and 8,221,540, comprise refractory fire containment panels 10 made of a refractory material comprising cement, a binder such as calcium silicate or aluminum silicate, water, and a matrix material. The matrix material comprises stainless steel fibers and/or organic fibers.

The presence of the matrix materials in the refractory fire containment panels 10, in particular the stainless steel fibers, ensures a reliable cold crushing strength value of the refractory concrete. However, the magnitude of the refractory fire containment panel's 10 strength to point impact is not increased significantly with the presence of stainless steel fibers. The addition of reinforcing materials 18 in the refractory matrix results in a reinforced refractory fire containment panel 100, 200 with an increased point of impact strength and ballistic resistance. The standard unreinforced panel can pass ballistics tests corresponding to Levels 1 through 3 of UL Standard 752. A properly reinforced refractory fire containment panel 100, 200 of the invention can pass ballistics tests corresponding to Levels 4 through 10 per UL Standard 752. This means that the bullet will not penetrate through the reinforced refractory fire containment panel 100, 200, nor create additional shrapnel upon impact. An added benefit of this type of reinforcement is that improved performance is gained with minimum weight or volume increase. Furthermore, the addition of reinforcing materials 18 also mitigates sound by reflection and/or absorption of the sound waves.

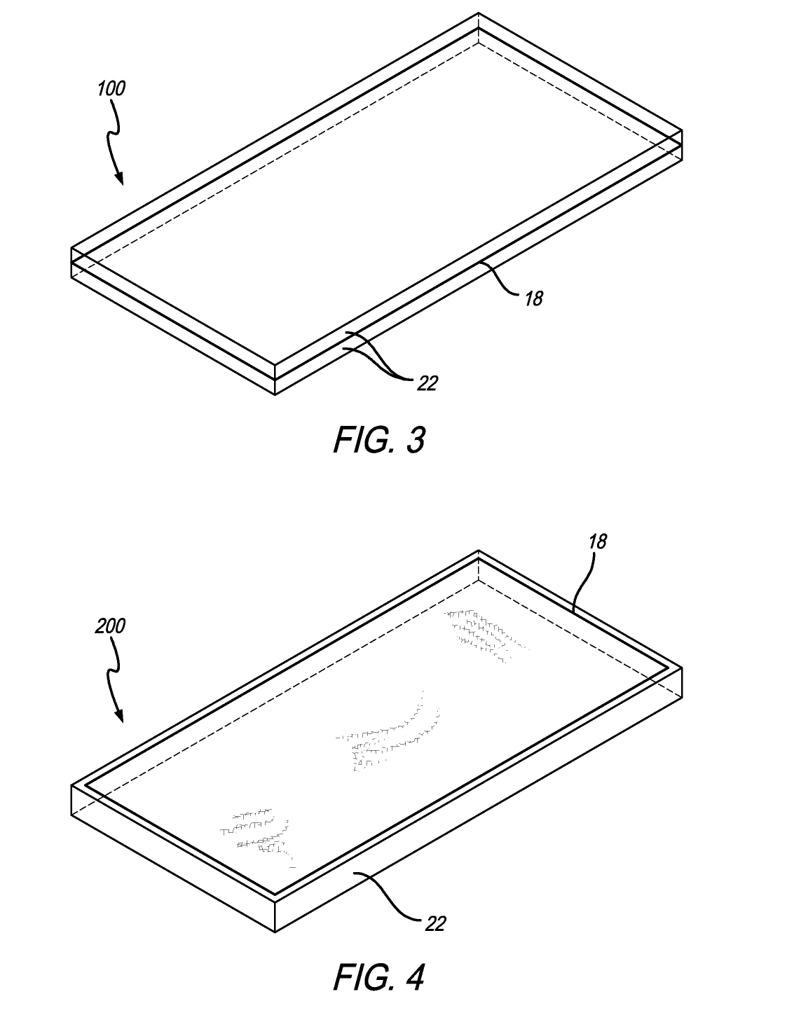

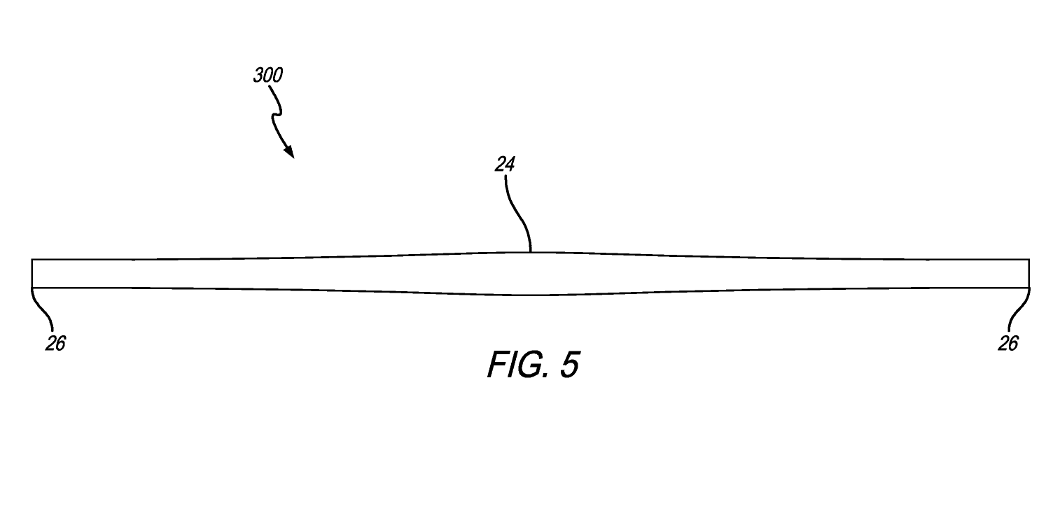

Depending on the application, this reinforcing material 18 can be an organic material such as, for example, aromatic polyamide (sold by DuPont under the trademark Kevlar®), carbon, composites, or an inorganic material such as, for example, stainless steel, graphene, or special high temperature glass. The reinforcing material 18 can be in various forms such as sheets of engineered cloth, mesh, and loose or bundled fibers. In use, one or multiple plies of the material can be added to the refractory concrete in several ways. The first way is direct addition of the reinforcing material 18 to the refractory concrete composition. The second way is that the reinforcing material 18 can be added during casting of the reinforced refractory fire containment panel, as shown in FIG. 3, forming an embedded refractory reinforced concrete panel 100. In this case, the refractory concrete material 22 is poured into a cast, partially filing the cast. The reinforcing material 18 is then added on top of the wet refractory concrete material 22, and the cast is filled with more refractory concrete material 22. The third way of making a reinforced refractory fire containment wall panel 200 is by attaching reinforcing material 18 to the front and/or back surfaces of the refractory fire containment panel 10, as shown in FIG. 4, and as described further below.

The refractory fire containment panel 10, 100, 200 can be cast into large panels suitable for use in constructing high temperature fire containment walls. Such large refractory fire containment panels 10, 100, 200 are typically between about 5 feet and about 10 feet in length, between about 2 feet and about 5 feet in width and between about 1 inch and about 3 inches in thickness. Such refractory fire containment panels 10, 100, 200 typically weigh between about 400 pounds and about 800 pounds.

Fire containment walls 16 made with refractory fire containment panels 10, 100, 200 can comprise a plurality of rectangular shaped refractory fire containment panels 10 disposed between vertical beams 12, such as illustrated in FIGS. 1 and 2. Both the panels 10 and the vertical beams 12 can be cast from the reinforced refractory composition of the invention.

The vertical beams 12 typically weigh in excess of 5000 pounds and are typically reinforced with rebar cages. Each vertical beam 12 preferably comprises a slot 14 into which a plurality of panels 10 can be stacked one on top of the other to form fire walls 16 of various shapes. The vertical beams 12 typically are attached to a traditional concrete foundation 20. Alternatively, the vertical beams 12 can be standard I beams or H beams (not shown) which have been clad with the refractory material.

In addition to forming a refractory fire containment wall panel 10 during casting of the panel, a refractory reinforced fire containment wall panel 200 can be made by retrofitting an existing refractory fire containment wall panel with reinforcing material such as, for example, organic material such as, Kevlar®, carbon, composites, or an inorganic material such as, stainless steel or special high temperature glass. To create the retrofitted refractory reinforced concrete panel 200, a cloth or mesh of the reinforcing materials re-enforcement method would be attached with an adhesive to the panel's front and/or back surfaces, as shown in FIG. 4. The attachment of the reinforcing materials would be by, for example, a fastener such as a bolt or screw, or an adhesive such as epoxy, silicone caulk, or polyvinyl acetate emulsion. Optionally, weather resistant coating such as, for example, polyurethane or polyurea (sold under the trademark RhinoArmor® by Rhino Linings Corporation, San Diego, Calif.) could be applied to the reinforcement material 18.

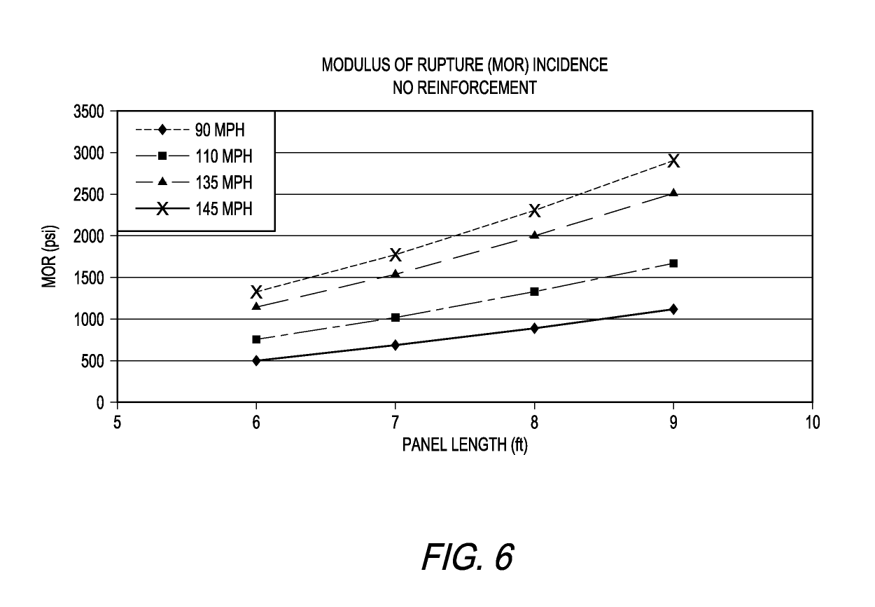

As described above, it is desirable to make refractory fire containment wall panels 10, 100, 200 as long as possible in order to decrease construction costs. The panel's bending strength is directly dependent on its thickness; therefore, a thicker panel is a stronger panel. The standard refractory fire containment wall panel 10, 100, 200 has a rectangular shape and is typically 2-inches thick. However, it was surprisingly found that the thickness of the reinforced refractory fire containment wall panel can be tapered from its longitudinal center 24 towards edges 26 of the panel, from 3 inches at the longitudinal center 24 to 2 inches at the edges 26, as shown in FIG. 5. A tapered refractory fire containment wall panel 300 has an increased bending strength, as described below.

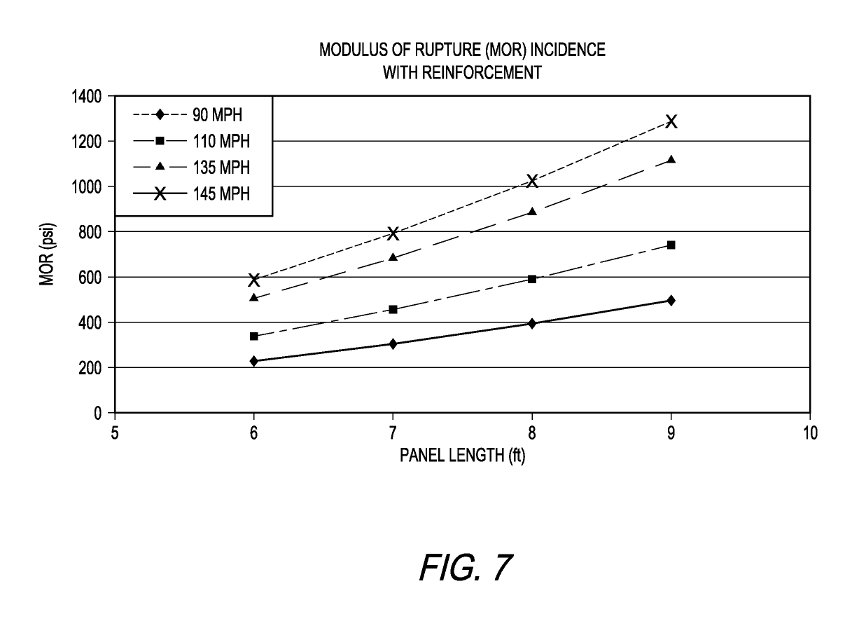

As shown in FIG. 6, the maximum standard refractory fire containment panel length that could safely withstand a 145 mph wind was about 6 feet, with a modulus of rupture strength of about 1,400 psi. In this example, 32 feet wide, 45 feet high refractory fire containment walls were built. The refractory fire containment walls had six columns spaced at 6½ feet apart. Twelve standard refractory fire containment panels, 2 inches thick each, were stacked between the columns FIG. 6 shows the modulus of rupture (MOR) as a function of panel length for a 2-inch thick standard refractory fire containment wall panel during four different wind speeds. FIG. 6 shows that in order to make a refractory fire containment wall panel at least 9 feet in length with no reinforcement, the refractory material's MOR must be greater than 1,500 pounds per square inch (PSI) with a wind speed of 110 miles per hour (mph). The standard refractory fire containment wall panel with had a greater than 1,500 PSI at a wind speed of 100 mph. Also as can be seen, the standard refractory fire containment wall panel that was 9 feet in length had a MOR of 2900 psi at a wind speed of 145 mph, which is the wind speed of a category 4 hurricane.

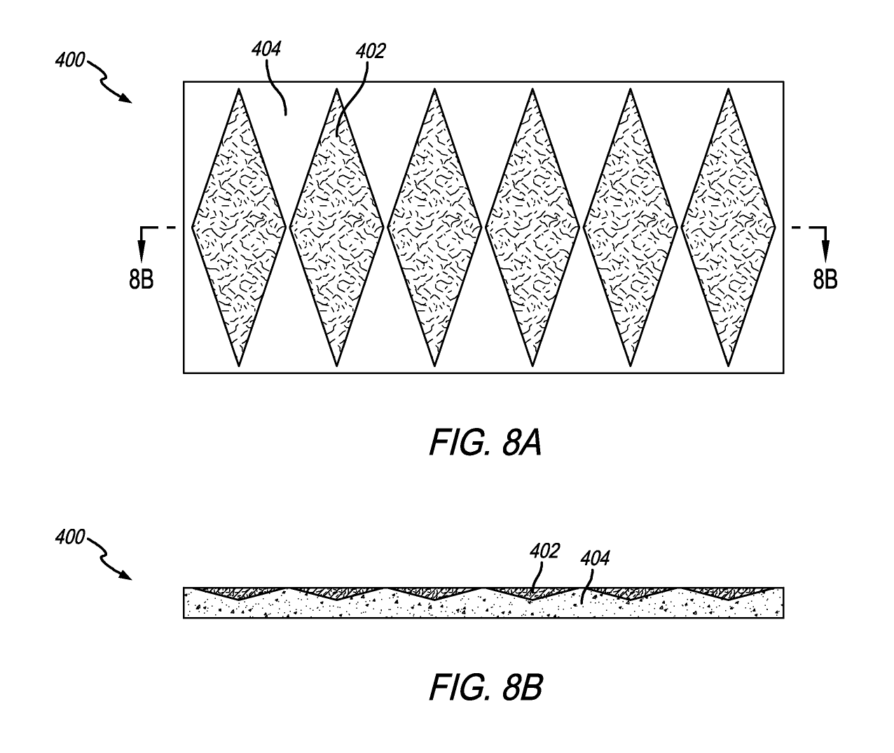

In contrast, the graph in FIG. 7 compares different lengths of a reinforced tapered refractory fire containment wall panel 300 of the invention, which tapered from a maximum longitudinal center 24 of 3 inches to 2 inches at the midpoint on both sides of the panel. The tapered reinforced refractory fire containment wall panels 300 used ranged from 6 feet to 9 feet in length. As can be seen in FIG. 7, the 9-foot tapered reinforced refractory fire containment wall panel had a MOR of 700 PSI at 110 mph. This is a substantial MOR gain in view of relatively small amount of additional material needed for a 9-foot long panel.

For fire walls containing the 8-foot wide tapered reinforced refractory fire containment wall panels 300, with a MOR of 1,000 PSI, only five columns would be necessary. The cost savings due to reduced material volume alone would be approximately 16% as compared to the standard refractory fire containment walls. An additional savings of about 10% would be possible from reduced fire wall foundation needs, which also results in lower shipping and lower fire wall assembly costs.

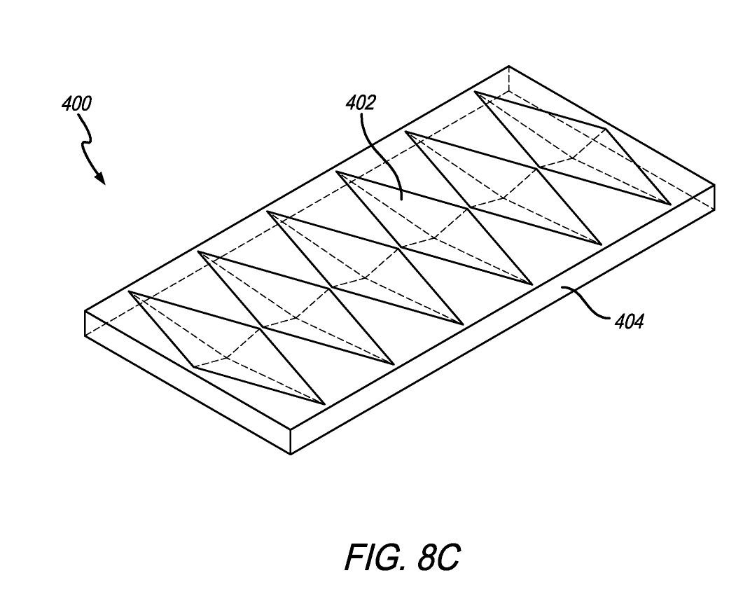

Further material reduction can be obtained by forming fingers or ribs 402 in the transverse direction of reinforced refractory fire containment wall panel 400, as shown in FIGS. 8A-8C. The ribs 402 can be created by hollowing out, or removing some of the reinforced refractory material 404 which would normally form the uniform taper. In practice, this is easily done by casting with the proper mold. The exact number and shape of ribs 402 would depend on the applied stresses expected for each application.

In addition, optimized performance and cost can be attained by applying in varying degrees combinations of the methods described above. For example, using a combination of a tapered reinforced refractory fire resistant wall panel with ribs formed in the transverse direction of the panel.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

1. A reinforced refractory fire containment wall panel, the panel cast from a refractory composition, wherein the refractory composition comprises:
a) a cement
b) a binder;
c) a matrix material comprising 300 series stainless steel fibers and organic fibers, and a refractory aggregate comprising aluminum oxide, calcium oxide, iron oxide and silicon dioxide or a combination thereof; and
d) a reinforcing material, wherein the reinforcing material is integral to the refractory composition.

2. The reinforced refractory fire containment wall panel of claim 1, wherein the reinforcing material can be an organic material.

3. The reinforced refractory fire containment wall panel of claim 2, wherein the organic material comprises aramid fibers, carbon, composites, or a combination thereof.

4. The reinforced refractory fire containment wall panel of claim 1, wherein the reinforcing material can be an inorganic material.

5. The reinforced refractory fire containment wall panel of claim 4, wherein the inorganic material comprises stainless steel, special high temperature glass, or a combination thereof.

6. A method of making a reinforced refractory fire containment wall panel, the method comprising the steps of:
a) pouring a panel comprising a refractory composition into a cast, the refractory composition comprising:
i) a cement;
ii) a binder; and
iii) a matrix material comprising 300 series stainless steel fibers and organic fibers, and a refractory aggregate comprising aluminum oxide, calcium oxide, iron oxide and silicon dioxide or a combination thereof;
b) adding reinforcing material to the panel cast from a refractory composition; and
c) pouring the refractory composition into the remaining area of the cast.

7. The method of making the reinforced refractory fire containment wall panel of claim 6, wherein the reinforcing material can be an organic material.

8. The method of making the reinforced refractory fire containment wall panel of claim 7, wherein the organic material comprises aramid fibers, carbon, composites, or a combination thereof.

9. The method of making the reinforced refractory fire containment wall panel of claim 6, wherein the reinforcing material can be an inorganic material.

10. The method of making the reinforced refractory fire containment wall panel of claim 9, wherein the inorganic material comprises stainless steel, special high temperature glass, or a combination thereof.

11. A method of making a reinforced refractory fire containment wall panel, wherein the method comprises combining:
a) a cement;
b) a binder;
c) a matrix material comprising 300 series stainless steel fibers and organic fibers, and a refractory aggregate comprising aluminum oxide, calcium oxide, iron oxide and silicon dioxide or a combination thereof; and
d) a reinforcing material.

12. The method of making the reinforced refractory fire containment wall panel of claim 11, wherein the reinforcing material can be an organic material.

13. The method of making the reinforced refractory fire containment wall panel of claim 12, wherein the organic material comprises aramid fibers, carbon, composites, or a combination thereof.

14. The method of making the reinforced refractory fire containment wall panel of claim 11, wherein the reinforcing material can be an inorganic material.

15. The method of making the reinforced refractory fire containment wall panel of claim 14, wherein the inorganic material comprises stainless steel, special high temperature glass, or a combination thereof.

16. The reinforced refractory fire containment wall panel of claim 1, wherein the reinforced refractory fire containment wall panel is resistant to the penetration from ballistics.

17. The reinforced refractory fire containment wall panel of claim 1, wherein the reinforced refractory fire containment wall panel mitigates sound.

18. The reinforced refractory fire containment wall panel of claim 1, wherein the reinforced refractory fire containment wall panel is at least 8 feet long.

19. The reinforced refractory fire containment wall panel of claim 18, wherein the reinforced refractory fire containment wall panel comprises a longitudinal center, a first and second side and a first and second edge.

20. The reinforced refractory fire containment wall panel of claim 19, wherein the longitudinal center of the reinforced refractory fire containment wall panel is about 3 inches, and the first and second sides of the reinforced refractory fire containment wall panel are about 2 inches.

21. The reinforced refractory fire containment wall panel of claim 19, wherein the reinforced refractory fire containment wall panel tapers from the longitudinal center, to the first and second sides of the reinforced refractory fire containment wall panel.

22. A reinforced refractory fire containment wall panel, wherein the wall panel comprises a longitudinal center, a first and second side and a first and second edge, wherein the wall panel tapers from the longitudinal center to the first and second sides of the reinforced refractory fire containment wall panel, and wherein the wall panel is at least 8 feet long, the panel cast from a refractory composition, wherein the refractory composition comprises:
a) a cement
b) a binder;
c) a matrix material comprising 300 series stainless steel fibers and organic fibers, and a refractory aggregate comprising aluminum oxide, calcium oxide, iron oxide and silicon dioxide or a combination thereof; and
d) a reinforcing material, wherein the reinforcing material is integral to the refractory composition.

23. The reinforced refractory fire containment wall panel of claim 22, wherein the reinforcing material can be an organic material.

24. The reinforced refractory fire containment wall panel of claim 22, wherein the reinforcing material can be an inorganic material.

25. The reinforced refractory fire containment wall panel of claim 24, wherein the inorganic material comprises stainless steel, special high temperature glass, or a combination thereof.
